(19) United States
(12) Patent Application Publication
(10) Pub. No.: US 2015/0352570 A1
(43) Pub. Date: Dec. 10, 2015

(54) FLUID SPRAYING DEVICE HOPPER QUICK DRAIN

(71) Applicant: GRACO MINNESOTA INC., Minneapolis, MN (US)

(72) Inventors: Christopher A. Lins, Crystal, MN (US); James C. Schroeder, Ramsey, MN (US); Roland M. Bedard, Lindstrom, MN (US); Steven H. Fredrickson, Minneapolis, MN (US)

(21) Appl. No.: 14/649,088

(22) PCT Filed: Jan. 29, 2014
(86) PCT No.: PCT/US14/13544

§ 371 Date: Jun. 2, 2015

Related U.S. Application Data
(60) Provisional application No. 61/759,037, filed on Jan. 31, 2013.

(51) Int. Cl. B05B 9/00; B05B 9/04; B05B 15/04

(52) U.S. Cl. CPC B05B 9/007; B05B 15/0437; B05B 9/0403

(57) ABSTRACT

In one example, a fluid spraying device includes a chassis, a plurality of wheels connected to the chassis, a spray tip assembly connected to the chassis, and a hopper mounted on the chassis. The hopper is in fluid communication with the spray tip assembly and is configured to be oriented in an upright draining position for draining fluid from the hopper. The hopper includes a bottom side, a top side opposite the bottom side and including an aperture configured to receive and drain the fluid, and a side wall extending at an obtuse angle away from the bottom side to the top side adjacent the aperture to facilitate draining of fluid when the hopper is in the upright draining position.

### CROSS-REFERENCE TO RELATED APPLICATION(S)

This application claims the benefit of U.S. PCT Application No. PCT/U.S.14/13544 filed Jan. 29, 2014 for “Fluid Spraying Device Hopper Quick Drain” by Christopher A. Lins, James C. Schroeder, Roland M. Bedard and Steven H. Fredrickson and U.S. Provisional Application No. 61/759,037 filed Jan. 31, 2013 for “Fluid Spraying Device Hopper Quick Drain” by Christopher A. Lins, James C. Schroeder, Roland M. Bedard and Steven H. Fredrickson.

### BACKGROUND

The present invention relates generally to fluid spraying devices that are used to spray fluids, such as paint, sealant, or other fluids. More particularly, the invention relates to fluid spraying devices having hoppers configured to hold fluid that is fed to the spraying device.

Fluid spraying devices are often used to spray lines or other markings on pavement, fields, or other surfaces. Often referred to as line markers or stripers, such devices typically include a spray nozzle assembly mounted to a chassis having wheels, thereby enabling a user to push or ride along with the device while applying markings to the ground. These devices typically include a hopper that holds fluid, such as paint, that is fed to the spray nozzle assembly for application, often accomplished via a motor or other pumping mechanism.

However, as is the case with field markers that apply paint to an athletic field, it can often be necessary to apply different colored paint to various portions of the field. Accordingly, when switching between colors of paint, it can be necessary to empty the hopper of an unused portion of a first color of paint prior to filling the hopper with a second color of paint. This process of emptying, possibly cleaning, and refilling the hopper can be inconvenient, especially if the spraying device is bulky and/or requires the use of tools for draining or cleaning the hopper.

### SUMMARY

In one example, a fluid spraying device includes a chassis, a plurality of wheels connected to the chassis, a spray tip assembly connected to the chassis, and a hopper mounted on the chassis. The hopper is in fluid communication with the spray tip assembly and is configured to be oriented in an upright draining position for draining fluid from the hopper. The hopper includes a bottom side, a top side opposite the bottom side, an aperture configured to receive and drain the fluid, and a side wall extending at an obtuse angle away from the bottom side to the top side adjacent the aperture to facilitate draining of fluid when the hopper is in the upright draining position.

In another example, a fluid spraying device includes a chassis, a spray tip assembly connected to the chassis, and a hopper mounted on the chassis. The hopper is in fluid communication with the spray tip assembly and is rotatable in the chassis between a spraying position and an upright draining position for draining fluid from the hopper. The hopper includes a bottom side, a top side opposite the bottom side, and a side wall. The aperture is configured to receive and drain the fluid. The side wall extends at an obtuse angle away from the bottom side to the top side adjacent the aperture to provide a fluid path from the bottom side to the aperture when the hopper is in the upright draining position.

In another example, a fluid spraying device includes a chassis, a spray tip assembly connected to the chassis, and a hopper removably mounted on the chassis. The hopper is in fluid communication with the spray tip assembly. The hopper is configured to be rotated in the chassis via two or more pivots of the chassis between a spraying position and an upright draining position for draining fluid from the hopper. Each of the two or more pivots includes a bottom side configured to support a load of the hopper during rotation between the spraying position and the upright draining position and an open top side configured to allow removal of the hopper from the pivots.

### BRIEF DESCRIPTION OF THE DRAWINGS

FIG. 1 is a perspective view of a fluid spraying device that includes a hopper configured to be positioned in an upright draining position.

FIG. 2 is a side view of the fluid spraying device of FIG. 1 with the hopper positioned in an upright draining position.

FIG. 3 is a side view of the fluid spraying device of FIGS. 1 and 2 with the hopper removed from the chassis.

FIG. 4 is a side view of another embodiment of a fluid spraying device that includes a chassis and hopper configured to be positioned in an upright draining position.

FIG. 5 is a side view of the fluid spraying device of FIG. 4 with the chassis and hopper positioned in the upright draining position.

### DETAILED DESCRIPTION

As described herein, a fluid spraying device, such as a walk-behind athletic field marker, includes a spray tip assembly connected to a chassis and configured to spray fluid (e.g., paint) that is fed from a hopper. Rather than require that the hopper be removed from the spraying device for draining and/or cleaning, a hopper according to techniques of this disclosure can be configured to be oriented in an upright draining position for draining fluid from the hopper. The hopper can be configured to discharge aft of the spraying device when oriented in the upright draining position, thereby enabling draining of the fluid directly into a fluid receptacle, such as a paint bucket. An angled side wall of the hopper can facilitate draining of the fluid, thereby helping to decrease an amount of excess paint remaining in the hopper after draining. Moreover, the spraying device can be configured to enable tool-less removal of the hopper from the chassis. In this way, techniques of this disclosure can enable the hopper to be easily removed and, for example, cleaned at a remote cleaning station, such as a sink or other cleaning location. As such, techniques described herein can enable quick, efficient, and tool-less draining and/or cleaning of a hopper that carries fluid, such as paint, for application by a fluid spraying device.

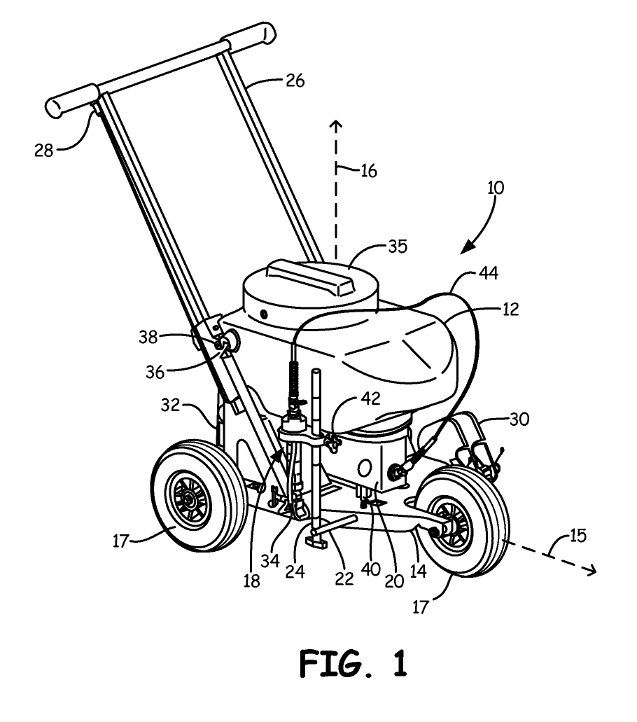

FIG. 1 is a perspective view of fluid spraying device 10 including hopper 12 that is configured to be oriented in an upright draining position. As illustrated, fluid spraying device 10 also includes chassis 14 having horizontal axis 15 and vertical axis 16, wheels 17, spray tip assembly 18, pump 20, horizontal guide arm 22, vertical guide arm 24, handlebar assembly 26, activator 28, spray guard 30, and battery 32. Spray tip assembly 18 includes spray tip 34. Hopper 12 includes cover 35, which is removably attached (e.g., via threads, a pressure fit, or other removable attachment mechanisms) to hopper 12 to cover an aperture in a top side of hopper 12. Chassis 14 includes pivots 36, which support a load of hopper 12 during rotation via studs 38, as is further described below.

A plurality of wheels 17 are connected to chassis 14 to allow movement of fluid spraying device 12 during application of fluid via spray tip assembly 18 on an application surface, such as an application surface coplanar with horizontal axis 15 (e.g., the ground). In the example of FIG. 1, spray tip assembly 18 is connected to chassis 14 via vertical guide arm 24, which extends from horizontal guide arm 22. In the example of FIG. 1, vertical guide arm 24 extends in a direction of vertical axis 16 such that vertical guide arm 24 is parallel with vertical axis 16. However, in some examples, vertical guide arm 24 may not be parallel with vertical axis 16, but may extend in a direction of vertical axis 16 at an acute angle from vertical axis 16.

Horizontal guide arm 22 is connected to chassis 14 and extends away from chassis 14 in a direction coplanar with horizontal axis 15. Horizontal guide arm 22 is connected to chassis 14 via thumbwheel screw 40. A thumbwheel screw can be a threaded fastener including a knob or other attachment that facilitates hand-threading of the fastener. Thumbwheel screw 40 enables adjustment of a distance between vertical guide arm 24 and chassis 14 via attachment to horizontal guide arm 22. For instance, a user can loosen thumbwheel screw 40, thereby allowing horizontal guide arm 22 to move away from or toward chassis 14, and can tighten thumbwheel screw 40 to secure horizontal guide arm 22 in a new position. In this way, thumbwheel screw 40 can enable tool-less adjustment (e.g., via hand loosening and tightening of thumbwheel screw 40) of a distance between vertical guide arm 24 and chassis 14 to alter a relative horizontal position between spray tip assembly 18 and chassis 14.

Spray tip assembly 18 is removably connected, in this example, to vertical guide arm 24 via thumbwheel screw 42. Thumbwheel screw 42 enables adjustment of a height of spray tip 34 above an application surface, such as the ground. For instance, a user can loosen thumbwheel screw 42, adjust a position of spray tip assembly 18 in a direction of vertical axis 16, and tighten thumbwheel screw 42 to secure spray tip assembly 18 at the new position. In this way, thumbwheel screw 42 can enable the adjustment of an effective spray height between spray tip 34 and the application surface, which can decrease and/or increase an area of a spray pattern applied to the application surface. For instance, when the spray height increases (i.e., the distance between spray tip 34 and the application surface increases), the area of the application surface that receives fluid from spray tip 34 can increase. Similarly, when the spray height decreases, the area of the application surface that receives fluid from spray tip 34 can decrease. Moreover, thumbwheel 42 can enable tool-less removal of spray tip assembly 18 from chassis 14. For instance, upon loosening of thumbwheel crew 42, spray tip assembly can be removed from vertical guide arm 24 by sliding the spray tip assembly off the top of vertical guide arm 24 in a direction of vertical axis 16.

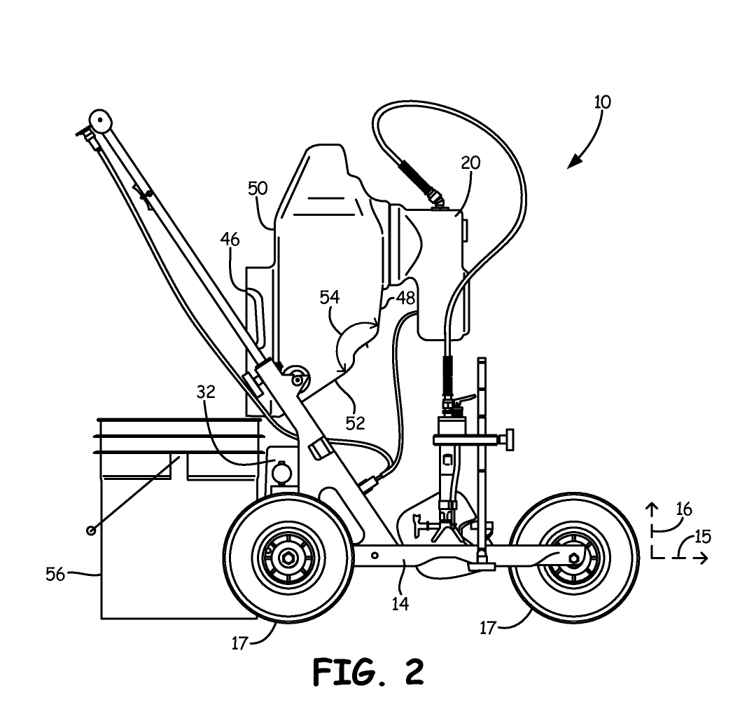

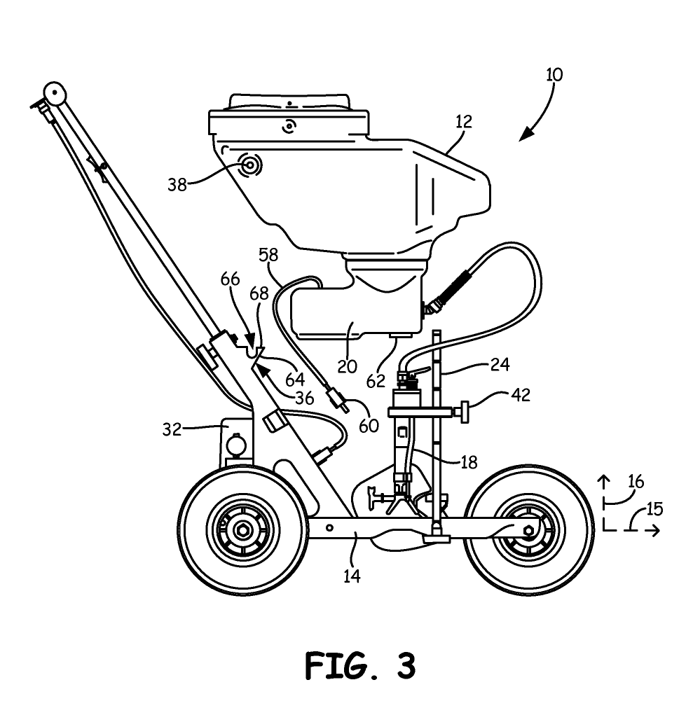

Hopper 12 is configured to hold fluid (e.g., paint) for application via spray tip assembly 18. Spray tip assembly 18 is fluidly connected to hopper 12 via hose 44 and pump 20. In operation, pump 20 draws fluid from hopper 12 via a port (not illustrated) in a bottom side of hopper 12 that allows egress of fluid from hopper 12, pressurizes the fluid, and discharges the pressurized fluid into spray tip assembly 18 via hose 44. As shown in FIGS. 2 and 3, pump 20 is electrically connected to battery 32 (e.g., a twelve volt battery), which is configured to supply electrical energy to pump 20 for operation of pump 20.

As illustrated, fluid spraying device 10 also includes activator 28 which, as illustrated, can be attached to handlebar assembly 26 to facilitate user actuation of activator 28. Activator 28 can be a button, switch, knob, or other device capable of setting a controlled state of pump 20. Activator 28 is electrically connected to a controller (not illustrated) that controls activation of pump 20. The controller, which can be separate or integral to battery 32, is electrically connected to battery 32 and pump 20. When activator 28 is positioned in an active position (e.g., depressed, or otherwise positioned in an active position), the controller causes pump 20 to draw electrical current from battery 32 to cause pump 20 to draw fluid from hopper 12 and discharge the pressurized fluid into spray tip assembly 18. When activator 28 is positioned in an inactive position, the controller does not cause pump 20 to draw the electrical current from battery 32, thereby effectively causing spraying device 10 to cease application of fluid via spray tip assembly 18.

In operation, a user can maneuver spraying device 10 along the application surface using handlebar assembly 26. Handlebar assembly 26 can be integrally formed from or attached to chassis 14, and extends from chassis 14 to a location aft of chassis 14. The user can position activator 28 to an active position (e.g., depress activator 28 when activator 28 is a button), thereby causing pump 20 to draw fluid from hopper 12, pressurize the fluid, and discharge the fluid to spray tip assembly 18 via hose 44. The pressurized fluid exits spray tip assembly 18 at spray tip 34, which dispenses the fluid by distributing droplets of the fluid in a spray pattern. When activator 28 is positioned to an inactive position, pump 20 ceases to draw the fluid from hopper 12, thereby ceasing application of the fluid via spray tip assembly 18. In this way, a user can apply the fluid to certain areas of the application surface and can prevent application of the fluid to other areas of the application surface. In addition, while illustrated in FIG. 1 in an inactive position (e.g., a position removed from spray tip assembly 18), in some examples, spray guard 30 can be positioned adjacent spray tip assembly 18 to shield spray tip 34 and prevent overspray of the fluid, thereby further controlling the application area of the fluid.

As further described herein, hopper 12 is configured to be oriented in an upright draining position for draining fluid from hopper 12. That is, in the example of FIG. 1, hopper 12 is illustrated in a spraying position configured to allow egress of fluid via a port in a bottom side of hopper 12 to pump 20 for application via spray tip assembly 18. As further described below, hopper 12 can be rotated between the spraying position and an upright draining position for discharge of the fluid aft of chassis 14. For instance, in the embodiment of FIG. 1, hopper 12 can be rotated from the spraying position to the upright draining position by rotating hopper 12 via pivots 36 in chassis 14 that are configured to support a load of hopper 12 during rotation. Pivots 36 include a bottom side having a concave recess that accepts studs 38 and enables rotation of hopper 12 within pivots 36 via studs 38. As described below, when hopper 12 is oriented in the upright draining position, fluid drains from hopper 12 via an aperture in the top side of hopper 12 (covered by cover 35 in FIG. 1) and discharges aft of chassis 14, thereby enabling direct deposit of the fluid into a receptacle (e.g., a paint bucket) positioned aft of chassis 14. In this way, hopper 12 can enable quick and efficient draining of fluid from hopper 12, thereby increasing usability of spraying device 10.

FIG. 2 is a side view of fluid spraying device 10 with hopper 12 positioned in an upright draining position. In the example of FIG. 2, cover 35 is removed to expose aperture 46, which can be configured to receive and/or drain fluid from hopper 12. As illustrated, hopper 12 can be a multifaceted container including multiple side walls and contours having various geometries for, e.g., directing fluid for egress to pump 20 and/or draining fluid via aperture 46.

As shown in FIG. 2, hopper 12 includes bottom side 48, top side 50 opposite bottom side 48, and side wall 52 extending from bottom side 48 at obtuse angle 54 to aperture 46 in top side 50. Side wall 52 is located at an aft side of hopper 12, such that fluids flows over side wall 52 when discharging through aperture 46 aft of chassis 14. Aperture 46 can be configured to receive and drain fluid. That is, an area of aperture 46 can be sufficiently large so as to enable fluid to be deposited (e.g., poured) into hopper 12 via aperture 46 without the use of funnels or other such tools.

As illustrated, hopper 12 can be oriented in the upright draining position such that bottom side 48 and top side 50 extend in a direction of vertical axis 16. Accordingly, when hopper 12 is in the upright draining position, side wall 52, extending at obtuse angle 54, provides a path for fluid to flow from bottom side 48 through aperture 46, thereby facilitating draining of fluid from hopper 12. In this way, side wall 52 can help to minimize an amount of fluid that remains in hopper 12 after draining fluid from hopper 12. Moreover, as illustrated in FIG. 2, aperture 46 can be configured to discharge fluid aft of chassis 14, thereby enabling direct deposit of the fluid into receptacle 56. That is, a distance between wheels 17 attached to an aft portion of chassis 14 can be greater than a width of receptacle 56 (e.g., a standard five gallon paint bucket or other fluid receptacle), thereby allowing receptacle 56 to abut chassis 14. In this way, hopper 12 can be configured to allow efficient draining of fluid from hopper 12 into a receptacle, thereby helping to minimize an amount of spilled fluid during draining.

FIG. 3 is a side view of fluid spraying device 10 with hopper 12 removed from chassis 14. As illustrated in FIG. 3, hopper 12 is connected to pump 20, which is electrically connected to battery 32 via wire 58 and removable plug 60. Removable plug 60 can include an interface that allows removable plug 60 to be connected to and disconnected from battery 32. Hopper 12 and pump 20 are removably mounted on chassis 14 such that seat 62 rests on chassis 14 to support a load of pump 20 and hopper 12 when hopper 12 is oriented in the spraying position.

Pivots 36 include bottom side 64 having concave recess 66 in top side 68 configured to accept studs 38 of hopper 12. Studs 38 rest in recess 66, and rotate within recess 66 during rotation of hopper 12 between the spraying position and the upright draining position. Pivots 36 support a load of hopper 12 via studs 38 during the rotation of hopper 12 between the spraying position and the upright draining position.

Because recess 66 does not fully enclose studs 38, studs 38 can be freely removed from pivots 36 in a direction of vertical axis 16. Similarly, because pump 20 is configured to rest on chassis 14 via seat 62, pump 20 and hopper 12 can be freely removed from chassis 14 in a direction of vertical axis 16. Accordingly, hopper 12, pump 20, and spray tip assembly 18 can be removed from chassis 14 upon disconnection of removable plug 60 from battery 32 and disconnection of spray tip assembly 18 from vertical guide arm 24 (e.g., by loosening thumbwheel screw 42). In this way, hopper 12 can be completely removed from chassis 14, thereby enabling hopper 12 to be cleaned and/or drained at a location that is remote from chassis 14.

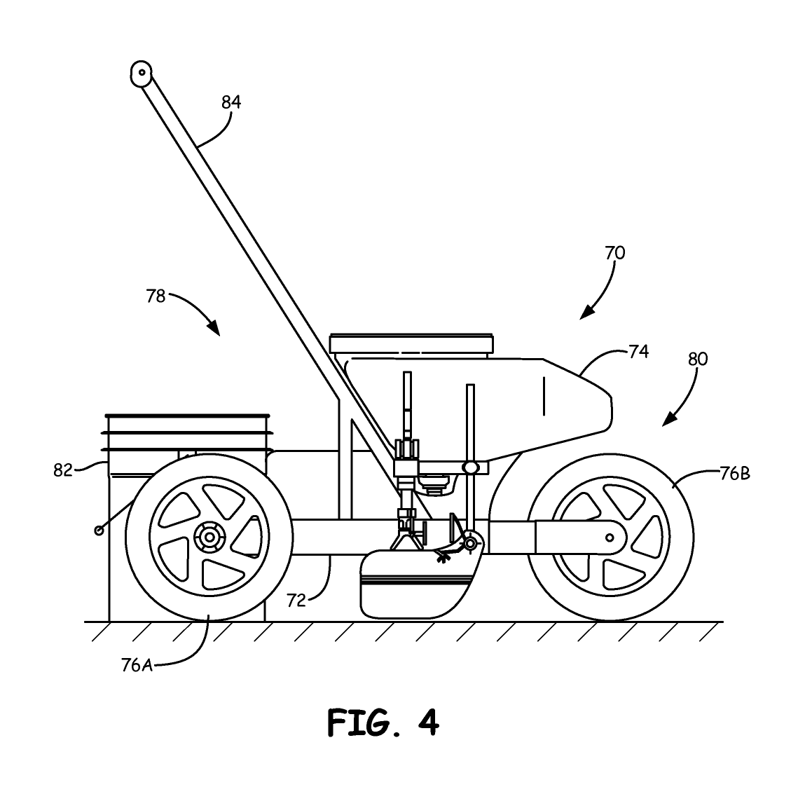

FIG. 4 is a side view of another embodiment of a fluid spraying device that includes a chassis and hopper configured to be positioned in an upright draining position. As illustrated, spraying device 70 includes chassis 72. Hopper 74 is connected to chassis 72. Wheels 76A (only one shown) are mounted to chassis 72 at aft portion 78 of chassis 72. Wheel 76B is mounted to chassis 72 at forward portion 80. While shown in FIG. 4 as including one wheel 76B, it should be understood that, in certain examples, more than one wheel 76B (e.g., two wheels, or other numbers of wheels) can be mounted to chassis 72 at forward portion 80.

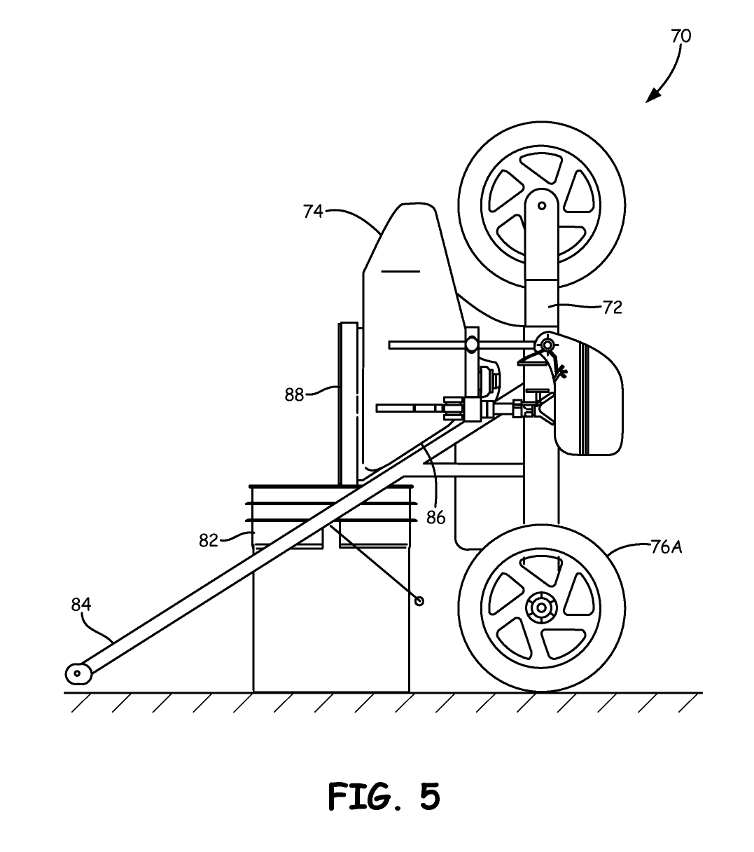

A distance between wheels 76A can be greater than a width of fluid receptacle 82 (e.g., a standard five gallon bucket), such that aft portion 78 can abut fluid receptacle 82. Handlebar assembly 84 extends from chassis 72 in a direction toward aft portion 80. In this embodiment, as is described below with respect to FIG. 5, hopper 74 is configured to be oriented in an upright draining position when chassis 72 is rotated about wheels 76A such that handlebar assembly 84 rests on the application surface, such as the ground.

FIG. 5 is a side view of the fluid spraying device 70 with chassis 72 and hopper 74 positioned in the upright draining position. As illustrated in FIG. 5, chassis 72 has been rotated about wheels 76A such that handlebar assembly 84 rests on the application surface. Thus, handlebar assembly 84 and wheels 76A provide a stable base for fluid spraying device 70 when chassis 72 and hopper 74 are in the upright draining position. Hopper 74 may have the same configuration as described above with respect to FIGS. 1-3. Accordingly, hopper 74 can be configured to discharge fluid aft of chassis 72, such that the fluid can drain directly into fluid receptacle 82. In addition, hopper 74 includes angled side wall 86 that provides a path for fluid to discharge through aperture 88, thereby facilitating draining and helping to minimize an amount of fluid that remains in hopper 74.

Although the present invention has been described with reference to preferred embodiments, workers skilled in the art will recognize that changes may be made in form and detail without departing from the spirit and scope of the invention.

1. A fluid spraying device comprising:
a chassis;
a plurality of wheels connected to the chassis;
a spray tip assembly connected to the chassis; and
a hopper mounted on the chassis in fluid communication with the spray tip assembly and configured to be oriented in an upright draining position for draining fluid from the hopper;
wherein the hopper comprises:
a bottom side;
a top side opposite the bottom side and including an aperture configured to receive and drain the fluid; and
a side wall extending at an obtuse angle away from the bottom side to the top side adjacent the aperture to facilitate draining of the fluid when the hopper is in the upright draining position.

2. The fluid spraying device of claim 1, wherein the aperture of the hopper is configured to discharge aft of the fluid spraying device when oriented in the upright draining position.

3. The fluid spraying device of claim 1, wherein the hopper is rotatable between a spraying position and the upright draining position via two or more pivots of the chassis, the two or more pivots configured to support a load of the hopper during rotation between the spraying position and the upright draining position.

4. The fluid spraying device of claim 3, wherein each of the two or more pivots comprise:
a bottom side extending in a direction of a horizontal axis of the chassis and configured to support the load of the hopper during rotation of the hopper between the spraying position and the upright draining position;
an open top side configured to allow removal of the hopper from the pivots in a direction of a vertical axis of the chassis; and
wherein the hopper includes studs for engaging the pivots.

5. The fluid spraying device of claim 3,
wherein each of the bottom side and the top side of the hopper extend in a direction of a horizontal axis of the chassis when the hopper is in the spraying position; and
wherein each of the bottom side and top side of the hopper extend in a direction of a vertical axis of the chassis when the hopper is in the upright draining position.

6. The fluid spraying device of claim 1, wherein a length of the bottom side of the hopper is less than a length of the top side of the hopper.

7. The fluid spraying device of claim 1,
wherein the hopper further comprises a port positioned at the bottom side of the hopper, the port configured to allow egress of the fluid from the hopper; and
wherein the fluid spraying device further comprises a pump positioned adjacent the port of the hopper and in fluid communication with the spray tip assembly, the pump configured to draw the fluid from the hopper through the port to the spray tip assembly.

8. The fluid spraying device of claim 1, wherein the spray tip assembly is removably attached to a guide arm.

9. The fluid spraying device of claim 8, further comprising:
a horizontal guide arm connected to the chassis and extending away from the chassis in a direction coplanar with a horizontal axis of the chassis; and
a vertical guide arm connected to the horizontal guide arm and extending in a direction of a vertical axis of the chassis;
wherein the spray tip assembly is removably attached to the vertical guide arm.

10. The fluid spraying device of claim 9, wherein the horizontal guide arm is movable along the direction coplanar with the horizontal axis of the chassis to enable movement of the vertical guide arm along the direction coplanar with the horizontal axis.

11. The fluid spraying device of claim 9, wherein the spray tip assembly is removably attached to the vertical guide arm to enable movement of the spray tip assembly in a direction of the vertical axis of the chassis.

12. The fluid spraying device of claim 8, further comprising a battery connected to the chassis and configured to provide electrical power to the pump, wherein the pump is electrically connected to the battery via a removable plug.

13. The fluid spraying device of claim 12, wherein the hopper is removable from the chassis in a direction of the vertical axis of the chassis upon removal of the spray tip assembly from the vertical guide arm and disconnection of the removable plug from the battery.

14. The fluid spraying device of claim 8, wherein the spray tip assembly is removably attached to the guide arm via a thumbwheel screw.

15. The fluid spraying device of claim 1,
wherein at least one of the plurality of wheels are connected to the chassis at an aft portion of the chassis; and
wherein the hopper is configured to be oriented in the upright draining position when the chassis is rotated about the at least one of the plurality of wheels connected to the chassis at the aft portion of the chassis.

16. The fluid spraying device of claim 15,
wherein the chassis further comprises a handle portion extending aft of the chassis; and
wherein the fluid spraying device is configured to rest on the handle portion and at least one of the plurality of wheels connected to the chassis at the aft portion of the chassis when the hopper is oriented in the upright draining position.

17. A fluid spraying device comprising:
a chassis;
a spray tip assembly connected to the chassis; and
a hopper mounted on the chassis in fluid communication with the spray tip assembly, the hopper rotatable in the chassis between a spraying position and an upright draining position for draining fluid from the hopper;
wherein the hopper comprises:
a bottom side;
a top side opposite the bottom side and including an aperture configured to receive and drain the fluid; and
a side wall extending at an obtuse angle away from the bottom side to the top side adjacent the aperture to provide a fluid path from the bottom side to the aperture when the hopper is in the upright draining position.

18. The fluid spraying device of claim 17,
wherein the hopper is rotatable in the chassis between the spraying position and the upright draining position via two or more pivots on the chassis, the two or more pivots configured to support a load of the hopper during the rotation.

19. A fluid spraying device comprising:
a chassis;
a spray tip assembly connected to the chassis; and
a hopper removably mounted on the chassis in fluid communication with the spray tip assembly, the hopper configured to be rotated in the chassis via two or more pivots of the chassis between a spraying position and an upright draining position for draining fluid from the hopper;
wherein each of the two or more pivots comprise a bottom side configured to support a load of the hopper during rotation between the spraying position and the upright draining position and an open top side configured to allow removal of the hopper from the pivots.

20. The fluid spraying device of claim 19, wherein the hopper comprises:
a bottom side;
a top side opposite the bottom side and including an aperture configured to receive and drain the fluid; and
a side wall extending at an obtuse angle away from the bottom side to the top side adjacent the aperture to facilitate draining of the fluid when the hopper is in the upright draining position.
